(19) United States
(12) Patent Application Publication
(10) Pub. No.: US 2026/0245536 A1
(43) Pub. Date: Aug. 20, 2026

(54) ACTIVE NOISE CONTROL DEVICE, VEHICLE, AND ACTIVE NOISE CONTROL METHOD

(71) Applicant: Panasonic Automotive Systems Co., Ltd., Kanagawa (JP)

(72) Inventor: Mitsuhiro TANI, Osaka (JP)

(73) Assignee: Panasonic Automotive Systems Co., Ltd., Kanagawa (JP)

(21) Appl. No.: 19/437,534

(22) Filed: Dec. 31, 2025

(30) Foreign Application Priority Data
Feb. 17, 2025 (JP) 2025-023353

(51) Int. Cl. G10K 11/178

(52) U.S. Cl. CPC G10K 11/17854; G10K 11/17879

(57) ABSTRACT

An active noise control device reduces noise at a position of an error signal source by outputting secondary sound from a secondary sound source in a space inside an automobile, and includes: a filter coefficient updater that updates an adaptive filter coefficient used for generating a control signal to be used for outputting the secondary sound; and a gain adjuster that adjusts a gain to be multiplied by the control signal, and, when an amplitude of a reference signal or an amplitude of an error signal is smaller than or equal to a threshold value, the filter coefficient updater stops updating the adaptive filter coefficient, and the gain adjuster reduces the gain to a negative target value.

### CROSS REFERENCE TO RELATED APPLICATION

The present application is based on and claims priority of Japanese Patent Application No. 2025-023353 filed on Feb. 17, 2025.

### FIELD

The present disclosure relates to active noise control devices that actively reduce noise by causing secondary sound to interfere with the noise.

### BACKGROUND

A known active noise control device in the related art actively reduces noise by outputting secondary sound. The secondary sound is used for canceling the noise and is output from a secondary sound source by using a reference signal correlated with the noise and an error signal based on residual sound obtained by interference between the noise and the secondary sound within a predetermined space (e.g., see Patent Literature 1).

### CITATION LIST

### Patent Literature

PTL 1: PCT International Publication No. WO 2014/006846

### SUMMARY

The present disclosure provides an active noise control device capable of improving upon the above related art.

An active noise control device according to an aspect of the present disclosure reduces noise at a position of an error signal source by outputting secondary sound from a secondary sound source in a space inside a vehicle, the active noise control device including: an adaptive filter that generates a control signal to be used for outputting the secondary sound, the control signal being generated by applying adaptive filtering to a reference signal having a correlation with the noise and output from a reference signal source attached to the vehicle; a simulated acoustic transfer characteristics filter that generates a filtered reference signal in which the reference signal is corrected using simulated acoustic transfer characteristics simulating acoustic transfer characteristics from a position of the secondary sound source to the position of the error signal source; a filter coefficient updater that updates an adaptive filter coefficient by using the filtered reference signal generated and an error signal output by the error signal source and corresponding to residual sound obtained by interference between the secondary sound and the noise; and a gain adjuster that adjusts a gain to be multiplied by the control signal, wherein when an amplitude of the reference signal or an amplitude of the error signal is smaller than or equal to a threshold value, the filter coefficient updater stops updating the adaptive filter coefficient, and the gain adjuster reduces the gain to a negative target value.

The active noise control device according to the aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating Configuration Example 1 of an active noise control device according to an embodiment.

FIG. 2 is a flowchart of basic operation of the active noise control device according to the embodiment.

FIG. 3 is a flowchart of Example 1 of gain adjustment operation of the active noise control device according to the embodiment.

FIG. 4 is a diagram illustrating Gain Adjustment Example 1.

FIG. 5 is a diagram illustrating Gain Adjustment Example 2.

FIG. 6 is a diagram illustrating Gain Adjustment Example 3.

FIG. 7 is a diagram illustrating Configuration Example 2 of the active noise control device according to the embodiment.

FIG. 8 is a flowchart of Example 2 of gain adjustment operation of the active noise control device according to the embodiment.

FIG. 9 is a diagram illustrating Gain Adjustment Example 4.

FIG. 10 is a diagram illustrating Gain Adjustment Example 5.

### DESCRIPTION OF EMBODIMENTS

Embodiments will be described in detail below with reference to the drawings. All of the embodiments to be described below are comprehensive or specific examples. Numerical values, shapes, materials, components, positions and connection methods of the components, steps, the order of the steps, and so on indicated in the embodiments below are examples, and are not intended to limit the present disclosure. Among the components in the embodiments below, components not indicated in the independent claims are described as arbitrary components.

Each drawing is a schematic view and is not necessarily a precise illustration. Substantially identical components in the drawings are given the same reference signs, and redundant explanations are omitted or simplified.

### Embodiment

### Configuration Example 1

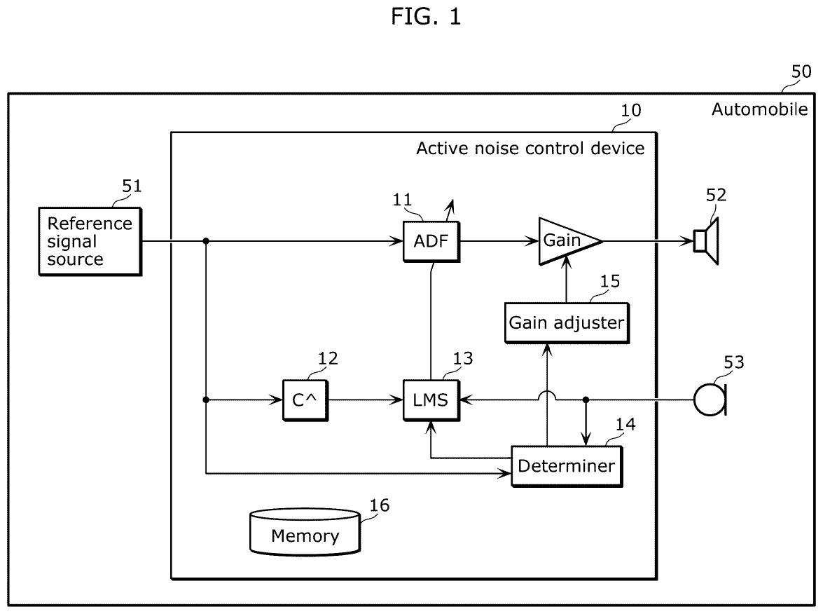

Configuration Example 1 of an active noise control device according to an embodiment will be described below. FIG. 1 is a diagram illustrating Configuration Example 1 of the active noise control device according to the embodiment. As illustrated in FIG. 1, automobile 50 includes reference signal source 51, secondary sound source 52, error signal source 53, and active noise control device 10.

Reference signal source 51 is a transducer that outputs a reference signal correlated with noise in a space inside automobile 50. Reference signal source 51 is, for example, an acceleration sensor and is disposed outside the space inside automobile 50. In detail, reference signal source 51 is attached to a sub-frame, a wheel housing, or the like. The position where reference signal source 51 is attached is not particularly limited. If reference signal source 51 is an accelerator sensor, active noise control device 10 can reduce a component of road noise included in the noise in the space inside automobile 50. Since the propagation path of road noise is complicated, a configuration with acceleration sensors disposed at multiple locations is effective. Reference signal source 51 may also be a microphone.

Secondary sound source 52 outputs secondary sound to the space inside automobile 50 by using a control signal. In the embodiment, secondary sound source 52 is a loudspeaker, but may output the secondary sound by using a drive mechanism, such as an actuator to vibrate a structural body (e.g., a sunroof) of a part of automobile 50. Automobile 50 may have multiple secondary sound sources 52 disposed therein. The position where secondary sound source 52 is attached is not particularly limited.

Error signal source 53 detects residual sound obtained by interference between the noise and the secondary sound in the space inside automobile 50, and outputs an error signal based on the residual sound. Error signal source 53 is a transducer, such as a microphone, and is desirably disposed in the space inside automobile 50, such as a headliner.

Active noise control device 10 performs signal processing on the reference signal acquired from reference signal source 51, so as to generate a control signal for causing secondary sound source 52 to output secondary sound. Secondary sound is for reducing noise in the space inside automobile 50.

Specifically, active noise control device 10 includes adaptive filter 11, simulated acoustic transfer characteristics filter 12, filter coefficient updater 13, determiner 14, gain adjuster 15, and memory 16. Adaptive filter 11, simulated acoustic transfer characteristics filter 12, filter coefficient updater 13, determiner 14, and gain adjuster 15 are implemented by, for example, a processor, such as a digital signal processor (DSP), or a microcomputer (hardware) executing a computer program (software) stored in memory 16. Memory 16 is realized by a semiconductor memory contained in or externally attached to the DSP.

### Basic Operation

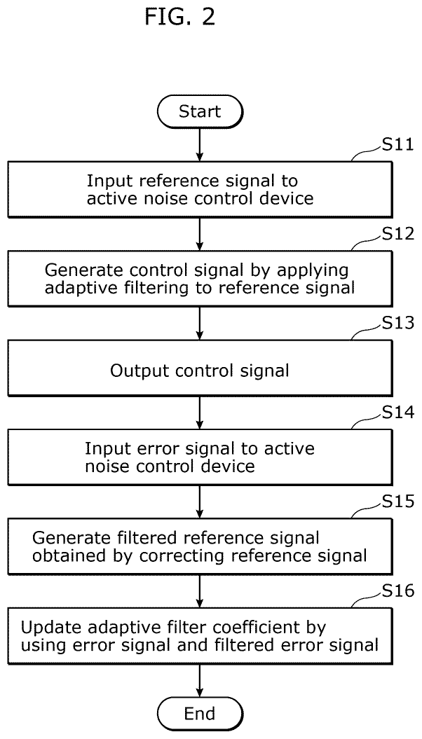

As mentioned above, active noise control device 10 performs noise reduction operation. First, the basic operation of active noise control device 10 will be described with reference to FIG. 2. FIG. 2 is a flowchart of the basic operation of active noise control device 10. The following description relates to a case where there is mainly one error signal source 53, and includes a complementarily case where there are multiple error signal sources 53.

First, a reference signal correlated to noise is input from reference signal source 51 to active noise control device 10 (S11).

The reference signal input to active noise control device 10 is output to adaptive filter 11 and simulated acoustic transfer characteristics filter 12.

Adaptive filter 11 generates a control signal (S12) by applying (convolving) adaptive filtering to the reference signal. Adaptive filter 11 is realized by a so-called finite impulse response (FIR) filter or infinite impulse response (IIR) filter. The control signal generated by adaptive filter 11 is multiplied by a gain adjustable by gain adjuster 15, and the control signal multiplied by the gain is output to secondary sound source 52 (S13). Secondary sound source 52 outputs secondary sound based on the control signal.

Error signal source 53 detects residual sound obtained by interference between the secondary sound output from secondary sound source 52 and noise, and outputs an error signal corresponding to the residual sound. In other words, the error signal indicates the state of noise in the space inside automobile 50 when the secondary sound is being output. As a result, the error signal is input to active noise control device 10 (S14). The error signal input to active noise control device 10 is output to filter coefficient updater 13.

Simulated acoustic transfer characteristics filter 12 generates a filtered reference signal (S15) in which the reference signal is corrected using simulated acoustic transfer characteristics that simulates acoustic transfer characteristics from the position of secondary sound source 52 to the position of error signal source 53 (i.e., the acoustic transfer characteristics in the space). For example, the simulated acoustic transfer characteristics are actually measured in advance in the space inside automobile 50 and are stored in memory 16. The simulated acoustic transfer characteristics may be defined based on an algorithm that does not use a preliminarily set value.

Filter coefficient updater 13 uses the error signal and the generated filtered reference signal to sequentially update adaptive filter coefficient W (S16). In detail, filter coefficient updater 13 uses the least mean square (LMS) method to calculate the adaptive filter coefficient such that the square sum of the error signal becomes minimum, and outputs the calculated adaptive filter coefficient to adaptive filter 11. When the error signal is expressed as e and a vector of the filtered reference signal is expressed as R, adaptive filter coefficient W is expressed by (Expression 1) below. In this case, n denotes a natural number and indicates an n-th sample in sampling cycle Ts. μ denotes a scalar quantity and indicates a step size parameter that determines an amount of update of adaptive filter coefficient W per sampling.

$$[ Expression 1 ]$$

$$W ( n + 1 ) = W ( n ) - μ e ( n ) R ( n ) . \qquad ( Expression 1 )$$

As described above, active noise control device 10 can generate the control signal by applying adaptive filtering, in which the coefficient is updated based on the error signal, to the reference signal.

### Example 1 of Gain Adjustment Operation

With the basic operation described above, noise attributable to road noise inside automobile 50 is reduced. However, other than the noise attributable to road noise, the noise audible inside automobile 50 includes other noises, such as noise attributable to wind noise and noise attributable to engine sound. When the noise attributable to road noise is excessively reduced, there is a problem in that the other noises become conspicuously audible.

When the magnitude of road noise is estimated to be small, active noise control device 10 stops the function for reducing noise and outputs secondary sound that slightly amplifies the noise attributable to road noise, so as to maintain the noise attributable to road noise at a certain magnitude without reducing it excessively. Accordingly, other noises are masked by the noise attributable to road noise, and the noise inside automobile 50 is maintained at a certain magnitude (i.e., fluctuation in the magnitude of the noise is reduced), thereby achieving an effect in which a user inside automobile 50 is less likely to perceive the noise.

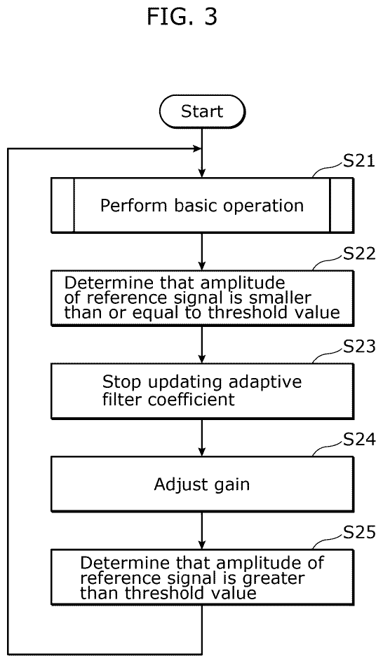

Example 1 of the above-described gain adjustment operation of active noise control device 10 will be described below. FIG. 3 is a flowchart of Example 1 of the gain adjustment operation.

When the basic operation described above is being performed (S21), determiner 14 acquires a reference signal from reference signal source 51 and determines whether the amplitude of the acquired reference signal is smaller than or equal to a threshold value. Specifically, it is determined whether the noise (e.g., road noise) is relatively small. This determination is performed continuously hereinafter. The threshold value is set in advance empirically or experimentally by a designer or the like of active noise control device 10.

When determiner 14 determines that the amplitude of the reference signal is smaller than or equal to the threshold value (S22), filter coefficient updater 13 stops updating the adaptive filter coefficient (S23), and gain adjuster 15 adjusts the gain to be multiplied by the control signal (S24). The order of step S23 and step S24 is not limited. For example, when determiner 14 determines that the amplitude of the reference signal is smaller than or equal to the threshold value, gain adjuster 15 may adjust the gain to be multiplied by the control signal, and filter coefficient updater 13 may stop updating the adaptive filter coefficient if the gain of the gain adjuster is smaller than or equal to a threshold value.

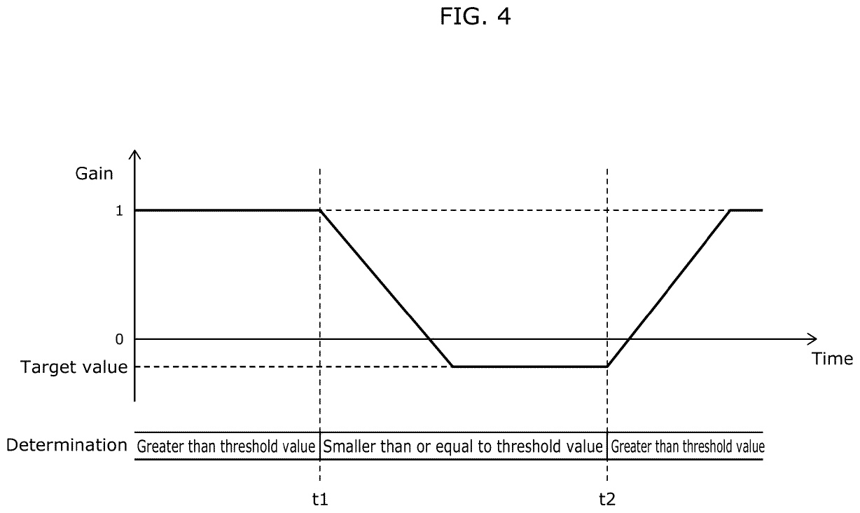

FIG. 4 is a diagram illustrating Gain Adjustment Example 1 by gain adjuster 15 (an example of temporal variation of gain). As illustrated in FIG. 4, during the basic operation, the gain is 1 (or a value close thereto). When the amplitude of the reference signal is smaller than or equal to the threshold value at timing t1, gain adjuster 15 reduces the gain to be multiplied by the control signal from 1 to a target value over a predetermined time period. The predetermined time period is, for example, about 0.1 seconds, but is not particularly limited.

For example, the target value is set to a value that decreases with decreasing amplitude of the reference signal (i.e., a value at the lower side of the ordinate axis in FIG. 4) based on, for example, the amplitude of the reference signal at a certain time point. The target value may be set in advance empirically or experimentally by the designer or the like of active noise control device 10. When the gain reaches the target value, gain adjuster 15 maintains the gain fixed at the target value.

Subsequently, when determiner 14 determines that the amplitude of the reference signal has exceeded the threshold value (S25), the basic operation resumes (S21). In detail, gain adjuster 15 increases the gain from the target value to 1 over a predetermined time period (see timing t2 and onward in FIG. 4), and filter coefficient updater 13 resumes the update of the adaptive filter coefficient. When the basic operation is to be resumed, the gain may be increased immediately from the target value to 1.

The target value may be a negative value. In Example 1 of the gain adjustment operation, the gain to be multiplied by the control signal in step S24 is undershot to a negative value. When the gain becomes negative, secondary sound having the same phase as the road noise is output from secondary sound source 52, so that the noise attributable to road noise audible by the user inside automobile 50 is amplified. Accordingly, other noises are masked by the noise attributable to road noise, and the noise inside automobile 50 is maintained at a certain magnitude (i.e., fluctuation in the magnitude of the noise is reduced), thereby achieving an effect in which the user inside automobile 50 is less likely to perceive the noise. Furthermore, since active noise control device 10 masks other noises by utilizing the function of active noise control device 10, a sense of discomfort felt by the user can be suppressed, as compared with a configuration that masks other noises by generating white noise, pink noise, and the like.

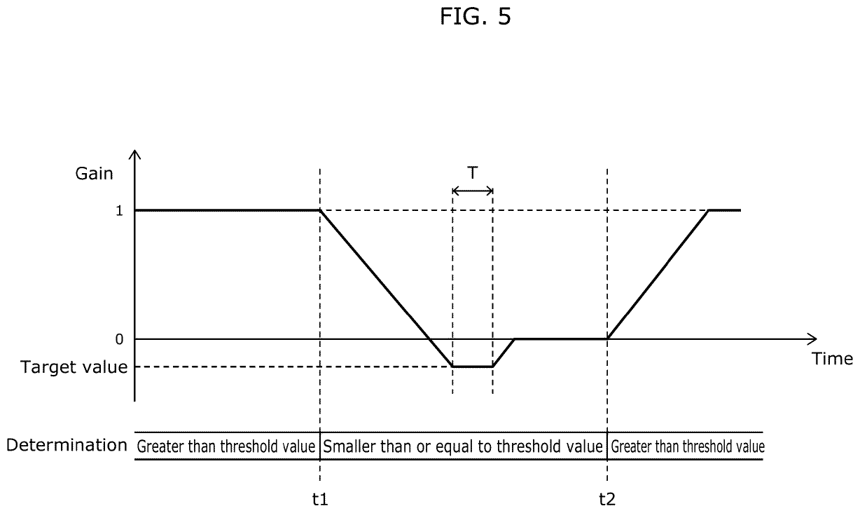

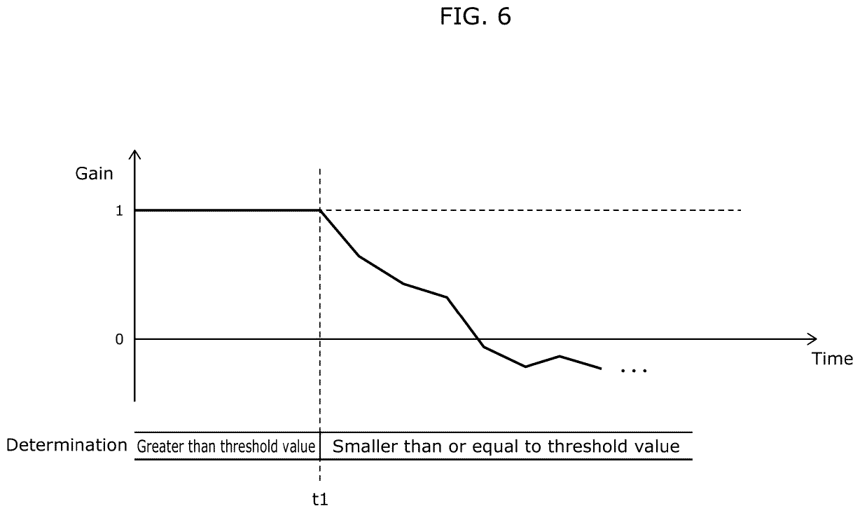

In step S24, the gain may be adjusted, as in FIG. 5 or FIG. 6. FIG. 5 is a diagram illustrating Gain Adjustment Example 2 by gain adjuster 15.

In Gain Adjustment Example 2 illustrated in FIG. 5, gain adjuster 15 reduces the gain to be multiplied by the control signal from 1 to a negative target value over a predetermined time period. The target value is set based on, for example, the amplitude of the reference signal at a certain time point, but may be set in advance empirically or experimentally by the designer or the like of active noise control device 10.

When the gain reaches the target value, gain adjuster 15 maintains the gain fixed at the negative value, and increases the gain from the negative value to 0 over the predetermined time period after elapse of fixed period T. Then, gain adjuster 15 maintains the gain fixed at 0. The duration of fixed period T is set in advance empirically or experimentally by the designer or the like of active noise control device 10. The duration of T may be 0 or longer, or may be 0.

With such a gain adjustment method, the gain ultimately becomes fixed at 0, so that a sense of discomfort felt by the user can be suppressed, while a relatively quiet environment can be ultimately achieved.

FIG. 6 is a diagram illustrating Gain Adjustment Example 3 by gain adjuster 15. In Gain Adjustment Example 3 illustrated in FIG. 6, the target value is not fixed, but is changed (i.e., varied) in accordance with the amplitude of the reference signal at that time. Specifically, in Gain Adjustment Example 3, the target value is updated (varied) momentarily, and every time the target value is updated, the gain is adjusted toward the changed target value. For example, the target value is updated to become a value that decreases with decreasing amplitude of the reference signal. Although the target value is updated continuously in Gain Adjustment Example 3, multiple target values corresponding to threshold values for multiple reference signals may be set. In this case, the target value is changed at a timing at which the set threshold value is exceeded, and the gain is adjusted toward the updated target value over a predetermined time period. Hysteresis may be provided in threshold determination.

With such a gain adjustment method, the magnitude of the noise attributable to road noise can be made more constant.

As an alternative to Example 1 of the gain adjustment operation described above in which it is determined whether the amplitude of the reference signal is smaller than or equal to the threshold value, it may be determined whether the amplitude of the error signal is smaller than or equal to a threshold value. In the description of Example 1 of the gain adjustment operation, the reference signal may be replaced with the error signal.

### Configuration Example 2

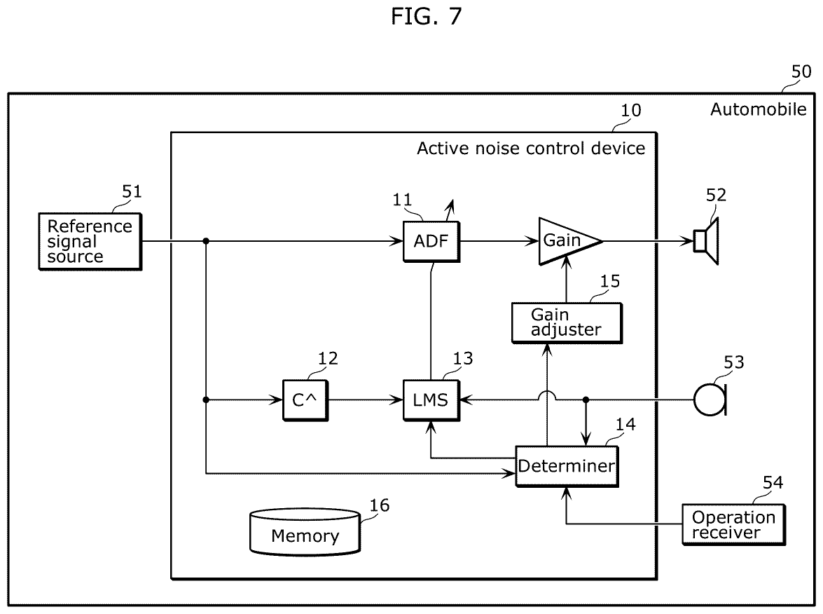

Next, Configuration Example 2 of active noise control device 10 will be described. FIG. 7 is a diagram illustrating Configuration Example 2 of active noise control device 10. Automobile 50 in Configuration Example 2 further includes operation receiver 54.

Operation receiver 54 receives, from the user, operations (on operation and off operation) for switching the noise reduction function of active noise control device 10 in Configuration Example 2 between enabled and disabled modes. Specifically, the noise reduction function of active noise control device 10 in Configuration Example 2 is switched between the enabled and disabled modes in accordance with a user operation performed on operation receiver 54. Operation receiver 54 is realized by, for example, a hardware button, but may alternatively be realized by a touchscreen.

### Example 2 of Gain Adjustment Operation

Although the gain is adjusted based on the amplitude of the reference signal or the amplitude of the error signal in Example 1 of the gain adjustment operation, a similar gain adjustment may be performed when the user performs an operation for switching the noise reduction function of active noise control device 10 from the enabled mode to the disabled mode.

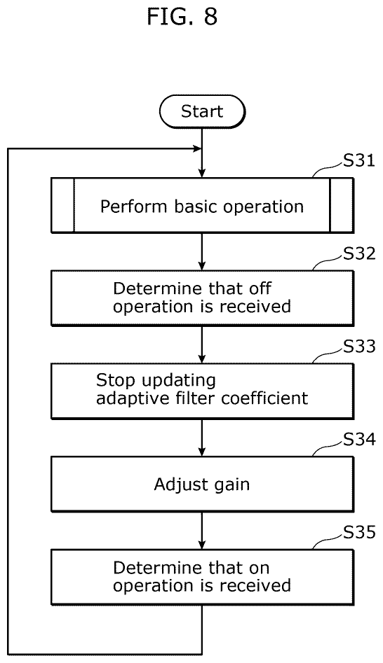

Example 2 of the gain adjustment operation performed by active noise control device 10 in Configuration Example 2 will be described below. FIG. 8 is a flowchart of Example 2 of the gain adjustment operation.

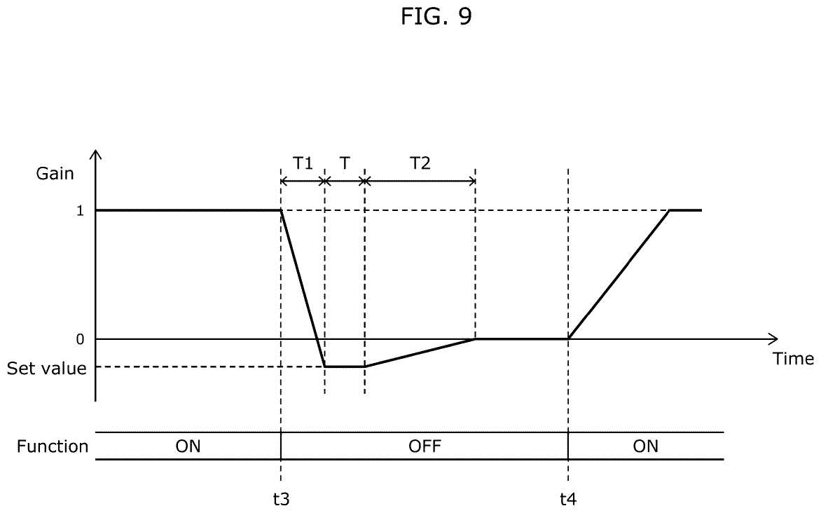

When the basic operation described above is being performed (S31), the user performs an off operation for switching the noise reduction function of active noise control device 10 from the enabled mode to the disabled mode on operation receiver 54, such as a push button or a touchscreen provided in automobile 50. When determiner 14 determines that the off operation is received (S32), filter coefficient updater 13 stops updating the adaptive filter coefficient (S33), and gain adjuster 15 adjusts the gain to be multiplied by the control signal (S34). The order to step S33 and step S34 is not limited. For example, when determiner 14 determines that the amplitude of the reference signal is smaller than or equal to the threshold value, gain adjuster 15 may adjust the gain to be multiplied by the control signal, and filter coefficient updater 13 may stop updating the adaptive filter coefficient if the gain of the gain adjuster is smaller than or equal to a threshold value. FIG. 9 is a diagram illustrating Gain Adjustment Example 4 by gain adjuster 15. As illustrated in FIG. 9, when it is determined that the off operation is received at timing t3, gain adjuster 15 reduces the gain to be multiplied by the control signal from 1 to a negative set value over first time period T1. The predetermined time period is, for example, about 0.1 seconds, but is not particularly limited. The negative set value may be set in advance empirically or experimentally by the designer or the like of active noise control device 10.

When the gain reaches the negative set value, gain adjuster 15 maintains the gain fixed at the negative set value, and increases the gain from the negative set value to 0 over second time period T2 after elapse of fixed period T. Then, gain adjuster 15 maintains the gain fixed at 0. The duration of fixed period T is set in advance empirically or experimentally by the designer or the like of active noise control device 10. The duration of T may be 0 or longer, or may be 0.

Subsequently, the user performs an on operation on operation receiver 54 to switch the noise reduction function of active noise control device 10 from the disabled mode to the enabled mode. When determiner 14 determines that the on operation is received (S35), the basic operation resumes (S31). In detail, gain adjuster 15 increases the gain from the negative set value to 1 over a predetermined time period (see timing t4 and onward in FIG. 9), and filter coefficient updater 13 resumes the update of the adaptive filter coefficient. When the basic operation is to be resumed, the gain may be increased immediately from the negative set value to 1.

In Example 2 of the gain adjustment operation described above, the gain to be multiplied by the control signal in step S34 is undershot to a negative value, and first time period T1 is set to be shorter than second time period T2. In other words, the duration of second time period T2 is set to be longer than first time period T1.

Accordingly, immediately after the state where the noise attributable to road noise is reduced by the basic operation, output of a phase-inverted control signal causes the noise attributable to road noise to be amplified, whereby the user can readily experience the noise reduction effect during the basic operation.

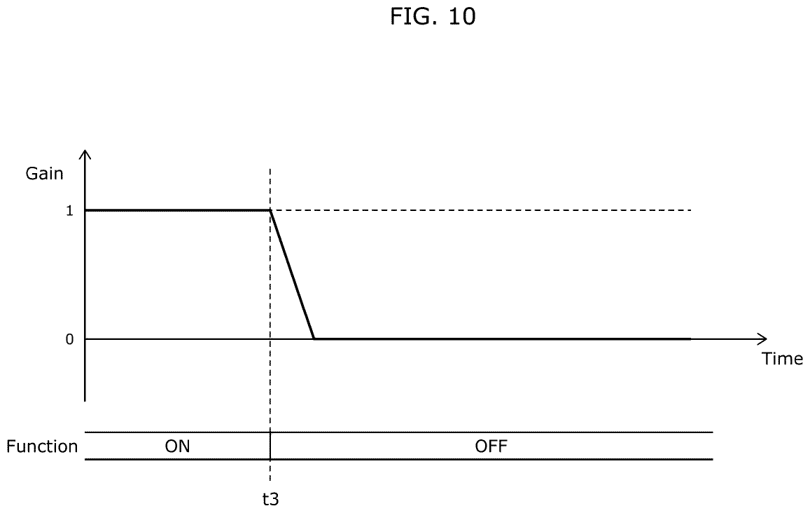

When active noise control device 10 switches the noise reduction function of active noise control device 10 from the enabled mode to the disabled mode as a fail-safe process or the like (i.e., when the noise reduction function is disabled from active noise control device 10 instead of the user), the phase-inverted control signal does not have to be output. In other words, the gain does not have to be undershot to a negative value. In this case, gain adjuster 15 decreases the gain from 1 to 0 over a predetermined time period and does not set the gain to a negative value. FIG. 10 is a diagram illustrating Gain Adjustment Example 5 by gain adjuster 15.

Accordingly, active noise control device 10 can suppress an unnecessary increase in the noise attributable to road noise.

### Variation

The description of the above embodiment relates to an example where the noise attributable to road noise masks other noises. However, active noise control device 10 may be a device that reduces noise attributable to engine sound, and may mask the other noises by using the noise attributable to engine sound. Specifically, active noise control device 10 may be a device that reduces a first noise, and may mask a second noise whose cause of generation is different from that of the first noise. In this case, the type of first noise is not particularly limited.

As an alternative to the above embodiment in which gain adjuster 15 changes the gain linearly when adjusting the gain, gain adjuster 15 may change the gain nonlinearly.

### Advantageous Effects, Etc.

The following description relates to techniques obtained from the content of disclosure of this description, as well as advantageous effects and the like achieved from the techniques.

Technique 1 provides active noise control device 10 that reduces noise at a position of error signal source 53 by outputting secondary sound from secondary sound source 52 in a space inside automobile 50. Active noise control device 10 includes adaptive filter 11, simulated acoustic transfer characteristics filter 12, filter coefficient updater 13, and gain adjuster 15. Adaptive filter 11 generates a control signal to be used for outputting the secondary sound by applying adaptive filtering to a reference signal having a correlation with the noise and output from reference signal source 51 attached to automobile 50. Simulated acoustic transfer characteristics filter 12 generates a filtered reference signal in which the reference signal is corrected using simulated acoustic transfer characteristics simulating acoustic transfer characteristics from a position of secondary sound source 52 to the position of error signal source 53. Filter coefficient updater 13 updates an adaptive filter coefficient by using the filtered reference signal generated and an error signal output by error signal source 53 and corresponding to residual sound obtained by interference between the secondary sound and the noise. Gain adjuster 15 adjusts a gain to be multiplied by the control signal. When an amplitude of the reference signal or an amplitude of the error signal is smaller than or equal to a threshold value, (a) filter coefficient updater 13 stops updating the adaptive filter coefficient, and (b) gain adjuster 15 reduces the gain to a negative target value. Automobile 50 is an example of a vehicle.

Active noise control device 10 described above reduces the gain to be multiplied by the control signal to the negative target value, thereby suppressing an excessive decrease in the noise audible inside automobile 50 and suppressing a situation where another noise whose cause of generation is different from that of the noise is perceived as loud.

Technique 2 is active noise control device 10 according to Technique 1 in which, gain adjuster 15 maintains the gain fixed at the negative target value after the gain reaches the negative target value.

Active noise control device 10 described above can suppress a sudden change in the magnitude of the noise by maintaining the gain fixed at the negative target value. In other words, active noise control device 10 can suppress a situation where the user perceives the noise as loud as a result of a sudden change in the magnitude of the noise.

Technique 3 is active noise control device 10 according to Technique 1 in which, gain adjuster 15 updates the negative target value based on the amplitude of the reference signal or the amplitude of the error signal while reducing the gain to the negative target value.

Active noise control device 10 described above can make the magnitude of the noise more constant.

Technique 4 is active noise control device 10 according to Technique 1 in which, gain adjuster 15 increases the gain to 0 after the gain reaches the negative target value.

Active noise control device 10 described above can ultimately achieve a relatively quiet environment by increasing the gain to 0.

Technique 5 is active noise control device 10 according to any one of Techniques 1 to 4 in which, when a user performs an operation for disabling a function of active noise control device 10, (a) filter coefficient updater 13 stops updating the adaptive filter coefficient, and (b) gain adjuster 15 reduces the gain to a negative set value over first time period T1 and subsequently increases the gain to 0 over second time period T2 that is longer than first time period T1.

Active noise control device 10 described above can assist the user in perceiving the noise reduction effect when the function of active noise control device 10 is enabled.

Technique 6 is active noise control device 10 according to Technique 5 in which, when the function of active noise control device 10 is to be disabled from active noise control device 10, (a) filter coefficient updater 13 stops updating the adaptive filter coefficient, and (b) gain adjuster 15 reduces the gain to 0 but does not set the gain to a negative value.

Active noise control device 10 described above can suppress an unnecessary increase in the noise.

Technique 7 provides automobile 50 including active noise control device 10 according to any one of Techniques 1 to 6, reference signal source 51, secondary sound source 52, and error signal source 53. Automobile 50 is an example of a vehicle.

Automobile 50 described above reduces the gain to be multiplied by the control signal to the negative target value, thereby suppressing an excessive decrease in the noise audible inside automobile 50 and suppressing a situation where another noise whose cause of generation is different from that of the noise is perceived as loud.

Technique 8 provides an active noise control method for reducing noise at a position of error signal source 53 by outputting secondary sound from secondary sound source 52 in a space inside automobile 50. The active noise control method includes: generating a control signal to be used for outputting the secondary sound, the control signal being generated by applying adaptive filtering to a reference signal having a correlation with the noise and output from reference signal source 51 attached to automobile 50; generating a filtered reference signal in which the reference signal is corrected using simulated acoustic transfer characteristics simulating acoustic transfer characteristics from a position of secondary sound source 52 to the position of error signal source 53; updating an adaptive filter coefficient by using the filtered reference signal generated and an error signal output by error signal source 53 and corresponding to residual sound obtained by interference between the secondary sound and the noise; and stopping the updating of the adaptive filter coefficient and reducing a gain to be multiplied by the control signal to a negative target value when an amplitude of the reference signal or an amplitude of the error signal is smaller than or equal to a threshold value. Automobile 50 is an example of a vehicle.

The active noise control method described above reduces the gain to be multiplied by the control signal to the negative target value, thereby suppressing an excessive decrease in the noise audible inside automobile 50 and suppressing a situation where another noise whose cause of generation is different from that of the noise is perceived as loud.

### OTHER EMBODIMENTS

Although the embodiment has been described above, the present disclosure is not limited to the above embodiment.

For example, in the above embodiment, the active noise control device is a device that performs noise control based on the filtered-X LMS algorithm, but may be implemented as a device that performs noise control based on the single-frequency adaptive notch filter (SAN) algorithm or the SAN filtered-X LMS algorithm.

The active noise control device according to the above embodiment may be installed in a vehicle other than an automobile. The vehicle may be, for example, an aircraft or a vessel. The present disclosure may be realized as such a vehicle other than an automobile.

The configuration of the active noise control device according to the above embodiment is an example. For example, the active noise control device may include a component, such as a digital-to-analog (DA) converter, a filter, a power amplifier, or an analog-to-digital (AD) converter.

The process to be performed by the active noise control device according to the above embodiment is an example. For example, the digital signal processing described in the above embodiment may partially be implemented by analog signal processing.

Furthermore, for example, in the above embodiment, a process to be executed by a specific processor may be executed by a different processor. Moreover, the order of multiple processes may be changed, or multiple processes may be executed concurrently.

In the above embodiment, each component may be implemented by executing a software program suitable for the component. Each component may be implemented by a program executer, such as a central processing unit (CPU) or a processor, reading and executing a software program recorded on a recording medium, such as a hard disk or a semiconductor memory.

In the above embodiment, each component may be realized by hardware. For example, each component may be a circuit (or an integrated circuit). These circuits may entirely constitute a single circuit, or may be separate circuits. Each of these circuits may be a general purpose circuit or a dedicated circuit.

Each component may be a circuit (or an integrated circuit). These circuits may entirely constitute a single circuit, or may be separate circuits. Each of these circuits may be a general purpose circuit or a dedicated circuit.

The general or specific aspects of the present disclosure may be implemented using a system, a device, a method, an integrated circuit, a computer program, or a non-transitory computer readable recording medium, such as a compact disc-read only memory (CD-ROM), or may be implemented using any combination of systems, devices, methods, integrated circuits, computer programs, or non-transitory computer readable recording media.

For example, the present disclosure may be implemented as an active noise control method executed by the active noise control device (i.e., a computer, such as a DSP), or may be implemented as a program for causing the active noise control device to execute the aforementioned active noise control method. The present disclosure may be implemented as an application program installed in a user interface device. The present disclosure may be implemented as a non-transitory computer readable recording medium having the program recorded thereon.

An embodiment obtained by applying each variation conceivable by a skilled person to each embodiment or an embodiment realized by arbitrarily combining components and functions in each embodiment within a scope that does not depart from the spirit of the present disclosure is also included in the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in its entirety: Japanese Patent Application No. 2025-023353 filed on Feb. 17, 2025.

### INDUSTRIAL APPLICABILITY

The active noise control device according to the present disclosure is useful as, for example, a device that can reduce noise inside an automobile cabin.

1. An active noise control device that reduces noise at a position of an error signal source by outputting secondary sound from a secondary sound source in a space inside a vehicle, the active noise control device comprising:
an adaptive filter that generates a control signal to be used for outputting the secondary sound, the control signal being generated by applying adaptive filtering to a reference signal having a correlation with the noise and output from a reference signal source attached to the vehicle;
a simulated acoustic transfer characteristics filter that generates a filtered reference signal in which the reference signal is corrected using simulated acoustic transfer characteristics simulating acoustic transfer characteristics from a position of the secondary sound source to the position of the error signal source;
a filter coefficient updater that updates an adaptive filter coefficient by using the filtered reference signal generated and an error signal output by the error signal source and corresponding to residual sound obtained by interference between the secondary sound and the noise; and
a gain adjuster that adjusts a gain to be multiplied by the control signal, wherein
when an amplitude of the reference signal or an amplitude of the error signal is smaller than or equal to a threshold value, the filter coefficient updater stops updating the adaptive filter coefficient, and the gain adjuster reduces the gain to a negative target value.

2. The active noise control device according to claim 1, wherein
the gain adjuster maintains the gain fixed at the negative target value after the gain reaches the negative target value.

3. The active noise control device according to claim 1, wherein
the gain adjuster updates the negative target value based on the amplitude of the reference signal or the amplitude of the error signal while reducing the gain to the negative target value.

4. The active noise control device according to claim 1, wherein
the gain adjuster increases the gain to 0 after the gain reaches the negative target value.

5. The active noise control device according to claim 1, wherein
when a user performs an operation for disabling a function of the active noise control device, the filter coefficient updater stops updating the adaptive filter coefficient, and the gain adjuster reduces the gain to a negative set value over a first time period and subsequently increases the gain to 0 over a second time period that is longer than the first time period.

6. The active noise control device according to claim 5, wherein
when the active noise control device switches the function of the active noise control device from an enabled mode to a disabled mode, the filter coefficient updater stops updating the adaptive filter coefficient, and the gain adjuster reduces the gain to 0 but does not set the gain to a negative value.

7. A vehicle comprising:
the active noise control device according to claim 1;
the reference signal source;
the secondary sound source; and
the error signal source.

8. An active noise control method for reducing noise at a position of an error signal source by outputting secondary sound from a secondary sound source in a space inside a vehicle, the active noise control method comprising:
generating a control signal to be used for outputting the secondary sound, the control signal being generated by applying adaptive filtering to a reference signal having a correlation with the noise and output from a reference signal source attached to the vehicle;
generating a filtered reference signal in which the reference signal is corrected using simulated acoustic transfer characteristics simulating acoustic transfer characteristics from a position of the secondary sound source to the position of the error signal source;
updating an adaptive filter coefficient by using the filtered reference signal generated and an error signal output by the error signal source and corresponding to residual sound obtained by interference between the secondary sound and the noise; and
stopping the updating of the adaptive filter coefficient and reducing a gain to be multiplied by the control signal to a negative target value when an amplitude of the reference signal or an amplitude of the error signal is smaller than or equal to a threshold value.
